(19) United States
(12) Patent Application Publication
(10) Pub. No.: US 2014/0346408 A1
(43) Pub. Date: Nov. 27, 2014

(54) METHOD OF MANUFACTURING GRAPHENE HYBRID MATERIAL AND GRAPHENE HYBRID MATERIAL MANUFACTURED BY THE METHOD

(71) Applicant: ELECTRONICS AND TELECOMMUNICATIONS RESEARCH INSTITUTE, Daejeon-city (KR)

(72) Inventors: Yong-Ju YUN, Daejeon (KR); Ki-Bong SONG, Daejeon (KR)

(73) Assignee: ELECTRONICS AND TELECOMMUNICATIONS RESEARCH INSTITUTE, Daejeon-city (KR)

(21) Appl. No.: 14/163,629

(22) Filed: Jan. 24, 2014

(30) Foreign Application Priority Data
May 23, 2013 (KR) 10-2013-0058230

(51) Int. Cl. H01B 1/04

(52) U.S. Cl. CPC H01B 1/04
USPC 252/503; 252/502; 252/507; 252/506; 252/511

(57) ABSTRACT

This invention relates to a method of manufacturing a graphene or graphene oxide/nanoparticle hybrid material and a graphene/nanoparticle hybrid material manufactured thereby, wherein the hybrid material can be easily, rapidly and eco-friendly synthesized while minimizing the use of chemicals and thermal treatment because of electrostatic self-assembly properties of a biomaterial. This method includes preparing nanoparticles, a biomaterial solution and a graphene oxide solution, mixing the nanoparticles with the biomaterial solution to form biomaterial-coated nanoparticles, mixing the biomaterial-coated nanoparticles with the graphene oxide solution to obtain a graphene oxide/nanoparticle hybrid material, and reducing the graphene oxide/nanoparticle hybrid material to obtain a graphene/nanoparticle hybrid material.

### CROSS REFERENCE TO RELATED APPLICATION

This application claims the benefit of Korean Patent Application No. KR 10-2013-0058230, filed May 23, 2013, which is hereby incorporated by reference in its entirety into this application.

### BACKGROUND OF THE INVENTION

1. Technical Field

The present invention relates to a method of manufacturing a graphene hybrid material and a graphene hybrid material manufactured by the method, and more particularly, to a method of easily manufacturing a graphene oxide or graphene hybrid material in a particle shape with a maximized surface area by use of a biomaterial enabling electrostatic self-assembly, and to a graphene hybrid material manufactured by the method.

2. Description of the Related Art

Recently, graphene hybrid materials are under active study in variety of fields including optoelectronic devices, biosensors, battery materials, and adsorbents for gases and pollutants because of unique optical and electrical properties thereof.

In particular, as hybrid materials composed of a variety of nanoparticles and graphene are reported to have a large adsorption area, superior gas adsorption capability, etc., thorough research thereto is ongoing these days.

To synthesize such hybrid materials, there have been published a variety of methods including mixing ionic particles and graphene and then performing thermal treatment, using a synthetic linker able to connect completed nanoparticles and graphene, etc.

However, these methods are problematic because of thermal treatment at high temperature, complicated synthesis processes and the like. Furthermore, synthesizing hybrid materials of graphene or graphene oxide sheets coupled with nanoparticles is complicated and difficult.

As a related technique, Korean Patent Application Publication No. 2011-0057989 (Composite structure of graphene and nanostructure and method of manufacturing the same) discloses a composite structure of two-dimensional graphene and a one-dimensional nanostructure and a method of manufacturing the composite structure.

As disclosed in Korean Patent Application Publication No. 2011-0057989, as a one-dimensional nanostructure is formed on two-dimensional graphene having high electrical conductivity, a three-dimensional composite structure may be obtained. Such a composite structure may be widely applied to various fields, including logic devices, memory devices, flexible and stretchable devices, etc.

As another related technique, Korean Patent No. 10-1210513 (Graphene composition having liquid crystalline property and method for preparing the same) discloses a graphene composition having liquid crystalline property and a preparation method thereof, wherein the composition is stable chemically and physically, shows a liquid crystalline phase in a wide temperature range, and has good compatibility with other compounds.

As disclosed in Korean Patent No. 10-1210513, graphene which enables mass production and has superior mechanical, chemical and electrical properties is imparted with a liquid crystalline property, and thereby graphene may be employed as a functional carbon material in diverse fields including nanocomposites, energy storing materials, photonics, etc.

As a further related technique, Korean Patent Application Publication No. 2013-0042845 (Method for adsorption of various biomaterials to chemically modified graphene) discloses adsorption of biomaterials onto chemically modified graphene.

As disclosed in Korean Patent Application Publication No. 2013-0042845, in order to adsorb a hydrophilic biomaterial onto hydrophobic graphene, a modification process is performed in such a manner that not only reduction for restoring electrical properties of graphene oxide prepared by oxidizing graphite but also nitrogen doping for adsorbing a hydrophilic biomaterial are carried out simultaneously, so that the biomaterial may be very efficiently and selectively adsorbed only onto the modified graphene, thereby manufacturing a composite substrate including a graphene layer which contains selectively adsorbed biomaterial and is patterned, making it possible to apply it to fabrication of flexible and conductive nano-sized electronic devices, circuits, biosensors, etc.

### SUMMARY OF THE INVENTION

Accordingly, the present invention has been made keeping in mind the above problems encountered in the related art, and an object of the present invention is to provide a method of manufacturing a graphene or graphene oxide/nanoparticle hybrid material and a graphene/nanoparticle hybrid material manufactured thereby, wherein the hybrid material may be easily, rapidly and eco-friendly manufactured while minimizing the use of chemicals and thermal treatment because of electrostatic self-assembly properties of a biomaterial.

In order to accomplish the above object, a preferred aspect of the present invention provides a method of manufacturing a graphene hybrid material, including preparing nanoparticles, a biomaterial solution and a graphene oxide solution; mixing the nanoparticles with the biomaterial solution to form biomaterial-coated nanoparticles; mixing the biomaterial-coated nanoparticles with the graphene oxide solution to obtain a graphene oxide/nanoparticle hybrid material; and reducing the graphene oxide/nanoparticle hybrid material to obtain a graphene/nanoparticle hybrid material.

Preferably, the nanoparticles are selected from the group consisting of Au (gold), Ag (silver), Pd (palladium), Pt (platinum), Ni (nickel), Cu (copper), Ru (ruthenium), Rh (rhodamine), TiO₂ (titanium dioxide), ZnO (zinc oxide), SnO₂ (tin dioxide), MnO₂ (manganese dioxide), Co₃O₄ (cobalt (II, III)), Fe₃O₄ (magnetite), NiO (nickel(II) oxide), Cu₂O (copper (I) oxide), RuO₂ (ruthenium dioxide), SiO₂ (silicon dioxide), CdS (cadmium sulfide) and CdSe (cadmium selenide).

Preferably, the biomaterial solution includes a biomaterial, and the biomaterial is selected from the group consisting of beta amyloid, bovine serum albumin, poly-L-lysine, collagen, fibrin, chitosan and gelatin.

Preferably, the biomaterial solution has a concentration of 0.005˜10 mg/ml.

Preferably, the graphene oxide solution includes graphene oxide and a solvent, and the solvent is selected from the group consisting of water, acetic acid (C₂H₄O₂), acetone (C₃H₆O), acetonitrile (C₂H₃N), benzene (C₆H₆), 1-butanol (C₄11₁₀O), 2-butanol (C₄H₁₀O), 2-butanone (C₄H₈O), t-butyl alcohol (C₄H₁₀O), carbon tetrachloride (CCl₄), chlorobenzene (C₆H₅Cl), chloroform (CHCl₃), cyclohexane (C₆H₁₂), 1,2-dichloroethane (C₂H₄Cl₂), dichlorobenzene, dichloromethane (CH₂Cl₂), diethyl ether (C₄H₁₀O), diethylene glycol (C₄11₁₀O₃), diglyme (diethylene glycol, dimethyl ether) (C₆11₁₄O₃), 1,2-dimethoxyethane (DME, glyme) (C₄H₁₀O₂), dimethylether (C₂H₆O), dimethylformamide (DMF) (C₃H₇NO), dimethyl sulfoxide (DMSO) (C₂H₆OS), dioxane (C₄H₈O₂), ethanol (C₂H₆O), ethyl acetate (C₄H₈O₂), ethylene glycol (C₂H₆O₂), glycerin (C₃H₈O₃), heptane (C₇H₁₆), hexamethylphosphoramide (HMPA) (C₆H₁₈N₃OP), hexamethylphosphorous triamide (HMPT) (C₆H₁₈N₃P), hexane (C₆H₁₄), methanol (CH₄O), methyl t-butyl ether (MTBE) (C₅H₁₂O), methylene chloride (CH₂Cl₂), N-methyl-2-pyrrolidinone (NMP) (CH₅H₉NO), nitromethane (CH₃NO₂), pentane (C₅H₁₂), petroleum ether (ligroine), 1-propanol (C₃H₈O), 2-propanol (C₃H₈O), pyridine (C₅H₅N), tetrahydrofuran (THF) (C₄H₈O), toluene (CAW, triethyl amine (C₆H₁₅N), o-xylene (C₈H₁₀), m-xylene (C₈H₁₀) and p-xylene (C₈H₁₀).

Preferably, the graphene oxide solution has a pH of 2-7.

Preferably, mixing the biomaterial-coated nanoparticles with the graphene oxide solution to obtain the graphene oxide/nanoparticle hybrid material is performed by synthesizing the graphene oxide/nanoparticle hybrid material using a self-assembly process in which the biomaterial-coated nanoparticles and the graphene oxide solution are self-assembled using a stirrer or ultrasonic waves.

Preferably, reducing the graphene oxide/nanoparticle hybrid material to obtain the graphene/nanoparticle hybrid material is performed by reducing the graphene oxide/nanoparticle hybrid material using a chemical reduction process, thus synthesizing the graphene/nanoparticle hybrid material.

Preferably, chemical reduction of the graphene oxide/nanoparticle hybrid material is performed at 20˜100° C.

Preferably, reducing the graphene oxide/nanoparticle hybrid material to obtain the graphene/nanoparticle hybrid material is performed by reducing the graphene oxide/nanoparticle hybrid material using a thermal reduction process, thus synthesizing the graphene/nanoparticle hybrid material.

Preferably, thermal reduction of the graphene oxide/nanoparticle hybrid material is performed at 100˜1500° C.

Another aspect of the present invention provides a method of manufacturing a graphene hybrid material, including mixing a nanoparticle solution with an appropriate amount of biomaterial so that the surface of nanoparticles is coated; preparing a graphene oxide solution which enables self-assembly with the nanoparticles containing a plurality of amide or amine groups; self-assembling the biomaterial-coated nanoparticles and graphene oxide, thus synthesizing a graphene oxide/nanoparticle hybrid material; and reducing the graphene oxide/nanoparticle hybrid material, thus synthesizing a graphene/nanoparticle hybrid material.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a process of manufacturing a graphene hybrid material according to an embodiment of the present invention;

FIGS. 2 to 6 are views illustrating a self-assembly process of graphene oxide and nanoparticles according to an embodiment of the present invention;

FIG. 7 is an electron microscope image illustrating a graphene/nanoparticle hybrid material according to an embodiment of the present invention; and

FIG. 8 is a transmission electron microscope (TEM) image illustrating the graphene/nanoparticle hybrid material according to the embodiment of the present invention.

### DESCRIPTION OF THE PREFERRED EMBODIMENTS

Hereinafter, a detailed description will be given of a method of manufacturing a graphene hybrid material and a graphene hybrid material manufactured thereby according to embodiments of the present invention with reference to the accompanying drawings. The terminologies or words used in the description and the claims of the present invention should not be interpreted as being limited merely to their common and dictionary meanings. Thus, examples described herein and configurations depicted in drawings are merely the most preferable embodiments of the present invention and do not represent the spirit of the present invention, and it should be understood that various equivalents and modifications able to substitute them be provided at the time of this application.

According to the present invention, a biomaterial having an appropriate concentration is added to a prepared nanoparticle solution so that the surface of nanoparticles is coated, after which the nanoparticles are immersed in a graphene oxide dispersion solution to perform self-assembly thus obtaining a graphene oxide/nanoparticle hybrid material, which is then reduced, thereby completing a graphene/nanoparticle hybrid material.

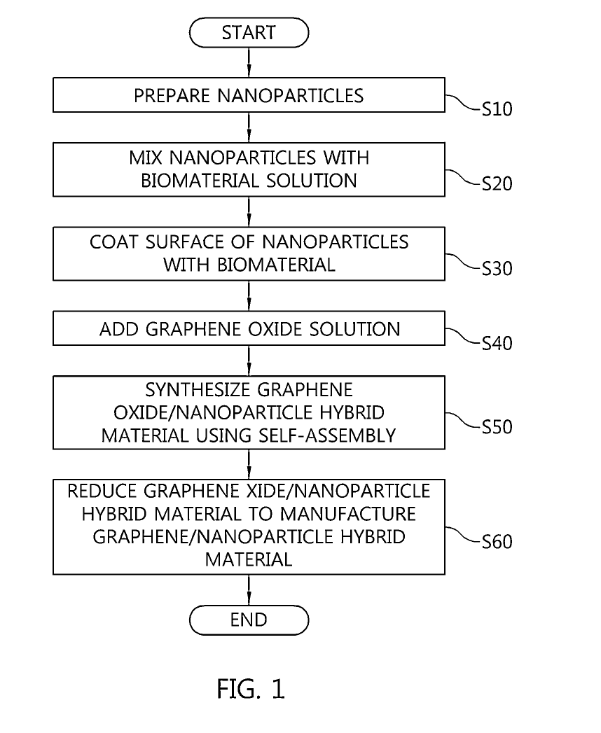

FIG. 1 is a flowchart illustrating a process of manufacturing a graphene hybrid material according to an embodiment of the present invention.

In S10, nanoparticles are prepared. The nanoparticles may be composed of any material including metals, oxides or semiconductors. For example, the nanoparticles may include at least one selected from the group consisting of Au (gold), Ag (silver), Pd (palladium), Pt (platinium), Ni (nickel), Cu (copper), Ru (ruthenium), Rh (rhodamine), TiO₂ (titanium dioxide), ZnO (zinc oxide), SnO₂ (tin dioxide), MnO₂ (manganese dioxide), Co₃O₄ (cobalt (II, III)), Fe₃O₄ (magnetite), NiO (nickel(II) oxide), Cu₂O (copper (I) oxide), RuO₂ (ruthenium dioxide), SiO₂ (silicon dioxide), CdS (cadmium sulfide) and CdSe (cadmium selenide).

In S20, the prepared nanoparticles are mixed with a biomaterial solution. The biomaterial solution may be prepared by mixing a biomaterial with distilled water. The biomaterial solution contains a biomaterial. For example, the biomaterial may include at least one selected from the group consisting of beta amyloid, bovine serum albumin, poly-L-lysine, collagen, fibrin, chitosan and gelatin. The concentration of the biomaterial solution is preferably set to the extent that the biomaterial may be uniformly applied onto the surface of the nanoparticles, and preferably approximates to 0.005˜10 mg/ml (more preferably 0.1˜1 mg/ml).

In S30, the surface of the nanoparticles is coated with the biomaterial. A stirrer or ultrasonic waves may be used so that the biomaterial is uniformly applied onto the surface of the nanoparticles. That is, when a mixture comprising the nanoparticles and the biomaterial solution is placed in a stirrer and blended, the surface of the nanoparticles may be coated with the biomaterial, thus forming biomaterial-coated nanoparticles. Alternatively, ultrasonic waves may be applied to the mixture comprising the nanoparticles and the biomaterial solution, so that the surface of the nanoparticles may be coated with the biomaterial.

In S40, the biomaterial-coated nanoparticles are mixed with a graphene oxide solution. The graphene oxide solution may be prepared by mixing graphene oxide sheets and a solvent. The hydrogen ion concentration of the graphene oxide solution is preferably set to about pH 2˜7 (more preferably pH 3˜5) so that electrostatic self-assembly of the biomaterial-coated nanoparticles and the graphene oxide occurs. The solvent may include at least one selected from the group consisting of water, acetic acid (C₂H₄O₂), acetone (C₃H₆O), acetonitrile (C₂H₃N), benzene (C₆H₆), 1-butanol (C₄H₁₀O), 2-butanol (C₄H₁₀O), 2-butanone (C₄H₈O), t-butyl alcohol (C₄H₁₀O), carbon tetrachloride (CCl₄), chlorobenzene (C₆H₅Cl), chloroform (CHCl₃), cyclohexane (C₆11₁₂), 1,2-dichloroethane (C₂H₄Cl₂), dichlorobenzene, dichloromethane (CH₂Cl₂), diethyl ether (C₄H₁₀O), diethylene glycol (C₄H₁₀O₃), diglyme (diethylene glycol, dimethyl ether) (C₆H₁₄O₃), 1,2-dimethoxyethane (DME, glyme) (C₄H₁₀O₂), dimethylether (C₂H₆O), dimethylformamide (DMF) (C₃H₇NO), dimethyl sulfoxide (DMSO) (C₂H₆OS), dioxane (C₄H₈O₂), ethanol (C₂H₆O), ethyl acetate (C₄H₈O₂), ethylene glycol (C₂H₆O₂), glycerin (C₃H₈O₃), heptane (C₇H₁₆), hexamethylphosphoramide (HMPA) (C₆H₁₈N₃OP), hexamethylphosphorous triamide (HMPT) (C₆H₁₈N₃P), hexane (C₆11₁₄), methanol (CH₄O), methyl t-butyl ether (MTBE) (C₅H₁₂O), methylene chloride (CH₂Cl₂), N-methyl-2-pyrrolidinone (NMP) (CH₅H₉NO), nitromethane (CH₃NO₂), pentane (C₅H₁₂), petroleum ether (ligroine), 1-propanol (C₃H₈O), 2-propanol (C₃H₈O), pyridine (C₅H₅N), tetrahydrofuran (THF) (C₄H₈O), toluene (C₇H₈), triethyl amine (C₆H₁₅N), o-xylene (C₈H₁₀), m-xylene (C₈H₁₀) and p-xylene (C₈H₁₀).

In S50, a graphene oxide/nanoparticle hybrid material is manufactured using a self-assembly process. Specifically, a stirrer or ultrasonic waves may be applied to the mixture comprising the biomaterial-coated nanoparticles and the graphene oxide solution as obtained in S40. That is, the graphene oxide/nanoparticle hybrid material may be manufactured using a self-assembly process in such a manner that the biomaterial-coated nanoparticles and the graphene oxide solution are self-assembled using a stirrer or ultrasonic waves.

Finally in S60, the graphene oxide/nanoparticle hybrid material is reduced, thus obtaining a graphene/nanoparticle hybrid material. Reducing the graphene oxide/nanoparticle hybrid material may be performed using a thermal, chemical or electrical reduction process. For example, a thermal reduction process is preferably carried out at about 100˜1500° C. to reduce the graphene oxide/nanoparticle hybrid material. On the other hand, a chemical reduction process is preferably performed at about 20˜100° C. (more preferably 20˜50° C.) to reduce the graphene oxide/nanoparticle hybrid material. As such, useful as the chemical reduction process is a vapor process for immersing the graphene oxide/nanoparticle hybrid material in a solution.

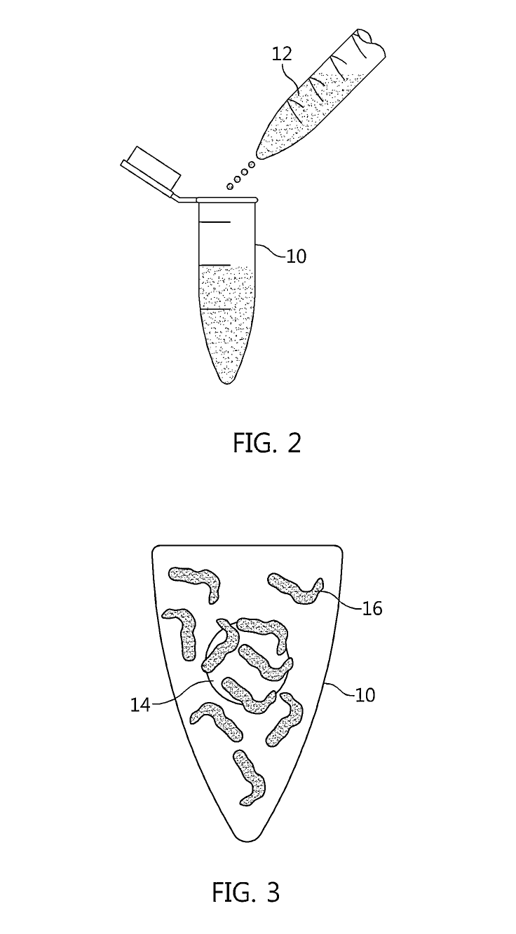

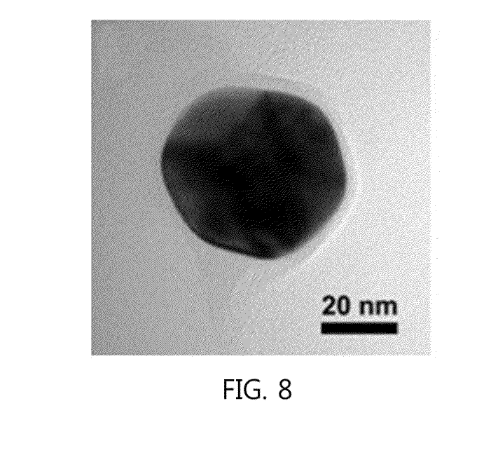

FIGS. 2 to 6 specifically illustrate a self-assembly process of graphene oxide and nanoparticles according to an embodiment of the present invention, FIG. 7 is an electron microscope image illustrating the graphene/nanoparticle hybrid material according to an embodiment of the present invention, and FIG. 8 is a TEM image illustrating the graphene/nanoparticle hybrid material according to the embodiment of the present invention.

As illustrated in FIG. 2, an appropriate amount of biomaterial solution 12 is placed in a vessel 10 containing nanoparticles. The biomaterial solution 12 includes biomaterial molecules.

Thus, as illustrated in FIG. 3, the vessel 10 contains nanoparticles 14 and biomaterial molecules 16, which are mixed together.

Subsequently, the nanoparticles 14 and the biomaterial molecules 16 in the vessel 10 are mixed using a stirrer, or ultrasonic waves are applied to the vessel 10, whereby the surface of the nanoparticles 14 is coated with the biomaterial molecules 16.

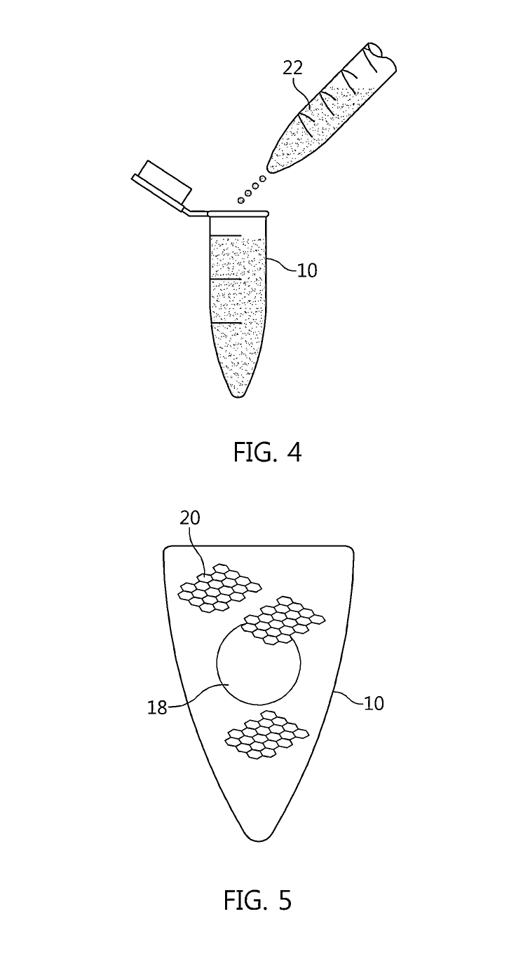

Subsequently, as illustrated in FIG. 4, an appropriate amount of graphene oxide solution 22 is placed in the vessel 10 containing nanoparticles having the biomaterial molecules 16 applied thereon.

The graphene oxide solution 22 includes graphene oxide sheets, and thus, as illustrated in FIG. 5, the vessel 10 contains nanoparticles 18 having the biomaterial molecules 16 applied thereon and graphene oxide sheets 20. The graphene oxide sheets 20 may refer to graphene oxide in sheet form.

The biomaterial-coated nanoparticle solution and the graphene oxide solution, which are uniformly dispersed in the solution, are mixed together, after which a hydrogen chloride (HCl) solution is added and thus the hydrogen ion concentration (pH) of the mixed solution is adjusted to 5.0 or less, so that electrostatic self-assembly occurs efficiently.

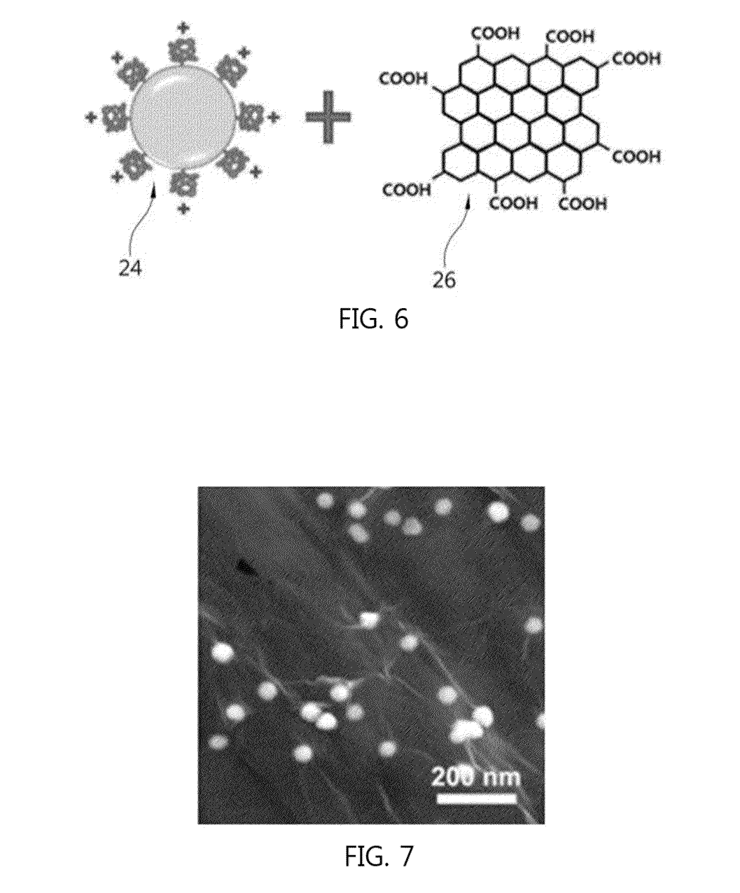

Thereby, as illustrated in FIG. 6, nanoparticles 24 having surface positive charges are self-coupled with graphene oxide 26 having negative charges, thus forming a graphene oxide/nanoparticle hybrid material.

Finally, the above hybrid material is reduced, thus manufacturing a graphene/nanoparticle hybrid material. The manufactured graphene/nanoparticle hybrid material is illustrated in FIG. 7 using an electron microscope, and is illustrated in FIG. 8 using TEM.

Below is a description of experimental examples for preparing nanoparticles 18 coated with biomaterial molecules.

<Experimental Example 1: Use of Beta Amyloid>

\textcircled{1} Beta amyloid powder was placed in a vessel containing distilled water, and mixed for 30 min using a stirrer.

\textcircled{2} The beta amyloid solution was added at a concentration ratio of 1:1 to a prepared nanoparticle solution, and allowed to react for 30 min using a stirrer.

<Experimental Example 2: Use of Bovine Serum Albumin (BSA)>

\textcircled{1} BSA powder was placed in a vessel containing distilled water, mixed for 30 min using a stirrer, and filtered once using a 200 nm membrane.

\textcircled{2} The BSA solution was added at a concentration ratio of 1:1 to a prepared nanoparticle solution, and allowed to react for 30 min using a stirrer.

Below is a description of an experimental example for synthesizing a graphene oxide/nanoparticle hybrid material.

\textcircled{1} A graphene oxide solution was prepared. Graphene oxide was prepared from graphite powder by the modified Hummers and Offenman's method. The graphene oxide powder was added in an amount of 0.01˜1 mg/ml to distilled water, after which the graphene oxide solution was dispersed for 4 hr using a sonication process.

\textcircled{2} The pH of the graphene oxide solution thus obtained was adjusted to 5.0 or less, after which the graphene oxide solution was mixed with the biomaterial-coated nanoparticle solution using a stirrer or ultrasonic waves. Amide groups formed on the surface of the nanoparticles and carboxylic groups formed on the surface of graphene oxide were subjected to electrostatic self-assembly, thus completing a graphene oxide/nanoparticle hybrid material.

Below is a description of an experimental example for synthesizing a graphene/nanoparticle hybrid material.

\textcircled{1} The graphene oxide/nanoparticle hybrid material obtained as above was diluted three times with distilled water, and centrifuged to remove uncoupled materials and impurities.

\textcircled{2} The diluted graphene oxide/nanoparticle hybrid material without impurities was added to a hydrazine solution so as to be reduced into a graphene/nanoparticle hybrid material, followed by three dilutions with distilled water and centrifugation, thus completing a graphene/nanoparticle hybrid material.

In accordance with the embodiment of the present invention as above, easy and rapid coupling of graphene with a variety of nanoparticles is provided, and thereby may be applied in a wide range of fields including bio, environment and energy fields.

As described hereinbefore, the present invention provides a method of manufacturing a graphene hydrbid material and a graphene hybrid material manufactured thereby. According to the present invention, it is possible to synthesize a graphene oxide- or graphene-wrapped nanoparticle hybrid material in a particle shape, which was conventionally difficult to manufacture using chemical or physical synthesis processes, and also such synthesis is easy regardless of materials such as metals, oxides, semiconductor nanoparticles, etc. Therefore, this hybrid material can be more simply manufactured compared to conventional graphene/nanoparticle hybrid materials, and thus can have active applications in any field including bio and environmental pollutant sensors, electrode materials of batteries, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing a graphene hybrid material, comprising:
preparing nanoparticles, a biomaterial solution, and a graphene oxide solution;
mixing the nanoparticles with the biomaterial solution to form biomaterial-coated nanoparticles;
mixing the biomaterial-coated nanoparticles with the graphene oxide solution to obtain a graphene oxide/nanoparticle hybrid material; and
reducing the graphene oxide/nanoparticle hybrid material to obtain a graphene/nanoparticle hybrid material.

2. The method of claim 1, wherein the nanoparticles are selected from the group consisting of Au (gold), Ag (silver), Pd (palladium), Pt (platinium), Ni (nickel), Cu (copper), Ru (ruthenium), Rh (rhodamine), TiO₂ (titanium dioxide), ZnO (zinc oxide), SnO₂ (tin dioxide), MnO₂ (manganese dioxide), Co₃O₄ (cobalt (II, III)), Fe₃O₄ (magnetite), NiO (nickel(II) oxide), Cu₂O (copper (I) oxide), RuO₂ (ruthenium dioxide), SiO₂ (silicon dioxide), CdS (cadmium sulfide) and CdSe (cadmium selenide).

3. The method of claim 1, wherein the biomaterial solution includes a biomaterial, and
the biomaterial is selected from the group consisting of beta amyloid, bovine serum albumin, poly-L-lysine, collagen, fibrin, chitosan and gelatin.

4. The method of claim 1, wherein the biomaterial solution has a concentration of 0.005˜10 mg/ml.

5. The method of claim 1, wherein the graphene oxide solution includes graphene oxide and a solvent, and
the solvent is selected from the group consisting of water, acetic acid (C₂H₄O₂), acetone (C₃H₆O), acetonitrile (C₂H₃N), benzene (C₆H₆), 1-butanol (C₄11₁₀O), 2-butanol (C₄H₁₀O), 2-butanone (C₄H₈O), t-butyl alcohol (C₄H₁₀O), carbon tetrachloride (CCl₄), chlorobenzene (C₆H₅Cl), chloroform (CHCl₃), cyclohexane (C₆H₁₂), 1,2-dichloroethane (C₂H₄Cl₂), dichlorobenzene, dichloromethane (CH₂Cl₂), diethyl ether (C₄H₁₀O), diethylene glycol (C₄H₁₀O₃), diglyme (diethylene glycol, dimethyl ether) (C₆H₁₄O₃), 1,2-dimethoxyethane (DME, glyme) (C₄H₁₀O₂), dimethylether (C₂H₆O), dimethylformamide (DMF) (C₃H₇NO), dimethyl sulfoxide (DMSO) (C₂H₆OS), dioxane (C₄H₈O₂), ethanol (C₂H₆O), ethyl acetate (C₄H₈O₂), ethylene glycol (C₂H₆O₂), glycerin (C₃H₈O₃), heptane (C₇H₁₆), hexamethylphosphoramide (HMPA) (C₆H₁₈N₃OP), hexamethylphosphorous triamide (HMPT) (C₆H₁₈N₃P), hexane (C₆H₁₄), methanol (CH₄O), methyl t-butyl ether (MTBE) (C₅H₁₂O), methylene chloride (CH₂Cl₂), N-methyl-2-pyrrolidinone (NMP) (CH₅H₉NO), nitromethane (CH₃NO₂), pentane (C₅H₁₂), petroleum ether (ligroine), 1-propanol (C₃H₈O), 2-propanol (C₃H₈O), pyridine (C₅H₅N), tetrahydrofuran (THF) (C₄H₈O), toluene (C₇H₈), triethyl amine (C₆H₁₅N), o-xylene (C₈H₁₀), m-xylene (C₈H₁₀) and p-xylene (C₈H₆).

6. The method of claim 1, wherein the graphene oxide solution has a pH of 2˜7.

7. The method of claim 1, wherein mixing the biomaterial-coated nanoparticles with the graphene oxide solution to obtain the graphene oxide/nanoparticle hybrid material is performed by synthesizing the graphene oxide/nanoparticle hybrid material using a self-assembly process in which the biomaterial-coated nanoparticles and the graphene oxide solution are self-assembled using a stirrer or ultrasonic waves.

8. The method of claim 1, wherein reducing the graphene oxide/nanoparticle hybrid material to obtain the graphene/nanoparticle hybrid material is performed by reducing the graphene oxide/nanoparticle hybrid material using a chemical reduction process, thus synthesizing the graphene/nanoparticle hybrid material.

9. The method of claim 8, wherein chemical reduction of the graphene oxide/nanoparticle hybrid material is performed at 20˜100° C.

10. The method of claim 1, wherein reducing the graphene oxide/nanoparticle hybrid material to obtain the graphene/nanoparticle hybrid material is performed by reducing the graphene oxide/nanoparticle hybrid material using a thermal reduction process, thus synthesizing the graphene/nanoparticle hybrid material.

11. The method of claim 10, wherein thermal reduction of the graphene oxide/nanoparticle hybrid material is performed at 100˜1500° C.

12. A graphene hybrid material, manufactured by the method of claim 1.
